(19) United States
(12) Patent Application Publication
(10) Pub. No.: US 2010/0019432 A1
(43) Pub. Date: Jan. 28, 2010

(54) Spacing element for plate-like elements

(75) Inventors: Jürg Zahnd, Utzenstorf (CH); Alessandro Chimenti, Ostermundingen (CH); Roman Polo, Bern (CH); Ruben Knaack, Basel (CH); Beat Strebel, Rodersdorf (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignee: 3S SWISS SOLAR SYSTEMS AG, Lyss (CH)

(21) Appl. No.: 12/357,560

(22) Filed: Jan. 22, 2009

(30) Foreign Application Priority Data
Jan. 23, 2008 (AT) A 90/2008

(51) Int. Cl. B23Q 3/00

(52) U.S. Cl. 269/296

(57) ABSTRACT

The invention describes a spacing element (33) for spacing apart if necessary plate-like elements (4) of a tempering element (25), with a carrier element (35), which comprises a first end area (36) which can face the plate-like element (4). In the section of the first end area (36) a flexible support element (37) is arranged, which projects beyond the carrier element (35). Furthermore, the invention also comprises a machine (1) with a spacing element (33).

The invention relates to a spacing element for spacing apart if necessary plate-like elements, such as photovoltaic elements, from a tempering element, such as a heating panel or cooling panel, with a carrier element which comprises a first end area that can face the plate-like element. Furthermore, the invention relates to a machine for producing plate-like elements.

In the production of plate-like elements made of composite material, for example photovoltaic elements, several layers, including glass, are joined together under pressure and heat. The machines used for this procedure in general have a heatable laminating station, a cooling station and transport means for intermittently conveying the elements. The laminating station in this case comprises a heating panel and on a top part, which can be lowered onto the heating panel, a membrane is provided, which in the lowered state forms a closed chamber with the heating panel. By evacuating said chamber the elements are degassed and the membrane is pushed by the pressure acting on the side of the membrane facing away from the chamber against the heating panel and the elements and presses the elements together.

From U.S. Pat. No. 6,149,757 A a laminating device is known for joining together plate-like elements, in which the laminating device forms at least one laminating section. Each of said laminating sections comprises in turn one upper and one lower chamber, whereby the two chambers are separated from one another by a membrane. The laminating device also comprises a heating panel for heating the material to be laminated. The latter heating panel is penetrated by pin-like support elements, which depending on the position of the heating element or the support elements space apart the material to be laminated from the heating panel. The material to be laminated is moved by its own lifting or conveying means into the laminating chamber and placed onto the support elements.

The support elements make it possible to hold the plate-like elements after insertion on the heating panel during the first phase of the heating at a defined distance from the heating panel, in order to allow the heating to be performed by radiation only. This allows a more even, slower heating than if the elements were to be in direct contact with the heating panel, and prevents the bending of the elements which would be caused by uneven contact with the heating panel. As soon as the elements have reached a sufficiently high temperature, so that they no longer bend on direct contact with the heating panel, they can then be lowered onto the latter for more rapid further heating.

In laminating machines, in which the elements to be laminated are conveyed by sliding devices or a transport belt onto the heating panel and after lamination are conveyed away, the support elements have to be lowered for inserting and removing the plate-like elements in the heating panel. Feeding onto the moved out pin-like spacing elements could damage the plate-like elements and/or the intermediate transport belt. Feeding with retracted spacing elements has the disadvantage however that the plate-like elements are already in contact with the heating panel plate during the insertion, and in addition the sections lying further to the front in transport direction of the plate-like elements are in direct contact with the heating panel for longer than the section further behind. In this way the advantages of slowly and evenly heating the plate-like elements are reduced.

The situation with the cooling device is similar but with opposite effects with the change in temperature of the plate-like elements. Here too, it is an advantage to begin the cooling as gently as possible and thus ensure in particular that the differences in temperature between the individual layers are kept as low as possible. Otherwise with some composite films there is a risk that at their point of hardening during the cooling process layers are bonded firmly to one another at a time when they are in a state of varying thermal longitudinal extension due to large differences in temperature. This can then in the cooled state result in considerable stresses in plate-like elements made of composite material.

The underlying objective of the invention is to create a spacing element and a machine equipped with such a spacing element, by means of which the said disadvantages are overcome and which makes it possible in particular to keep the elements to be heated or cooled during transport onto the tempering element spaced apart vertically from the latter, without the risk that the elements and/or a possibly used conveyor belt are stressed excessively by the spacing elements.

Said objective of the invention is achieved in that in the section of the first end area a flexible support element is arranged which projects beyond the carrier element.

The surprising advantage resulting from the features of the characterising part of claim 1 is that by means of the flexible support element an intermediate member is created which is elastically deformable in relation to the carrier element, which intermediate member supports the plate-like element if necessary with the interconnection of the transport belt. By means of this additional support element the support surface is designed to be variable and elastic and thus a point-like or linear support is avoided. Furthermore, by means of the flexible design of the support element a transport movement is also allowed in a raised position of the plate-like elements from the tempering element, as by means of the interconnection of the support element a so-called floating support is created for the plate-like element and thus inaccuracies in the relative height arrangement of the spacing elements can be balanced out. Furthermore, by means of the flexible design of the support element an automatic restoring is performed even over a long period, whereby a reliable period of operation can be achieved. In this way a non-rigid support plane is created, which within certain tolerances allows a secure support with simultaneous transport on the support element.

Also a further embodiment according to claim 2 is advantageous, as in this way the load reduction can be distributed over a larger surface and in this way it is possible to achieve better support with additional height adjustment. Furthermore, an embodiment according to claim 3 is advantageous, as thus in the smallest space an optimum supporting effect can be achieved in the flexible area. In addition, by means of the number and selection of the individual threads or strands the restoring behaviour and the sliding properties can be adapted to very different applications.

By means of the embodiment according to claim 4 it is still possible, without additional holding means being required, to achieve a stable alignment and securing of the support element on the carrier element. Furthermore, in this way a predetermined positional alignment of the support element relative to the carrier element can be achieved.

In another embodiment variant according to claim 5 a continual sharp-edged transition is avoided, whereby the period of use of the support element can also be increased even with strong deformations relative to the carrier element.

A development according to claim 6 is also advantageous, as thus in a simple manner it is possible to take into account very different operating conditions and if necessary a rapid refitting of the entire system or machine is possible.

In the embodiment according to claim 7 it is an advantage that in this way with the least space requirement a reliable support of the plate-like element on the spacing element or spacing elements is made possible, and in this way the tempering surface required for the tempering procedure is maintained almost fully.

However, the objective of the invention is also achieved independently by means of the configuration of the machine for producing plate-like elements by the features given in claim 8. It is advantageous in this case that by means of the flexible support elements an intermediate member that is elastically deformable in relation to the support element is created which supports the plate-like element. By means of said additional support elements the support surface is designed to be variable and elastic and thus a point-like or linear support is avoided. Furthermore, by means of the flexible configuration of the support elements a transport movement is made possible even in a raised position of the plate-like elements from the tempering element, as by means of the interconnection of the support elements a floating bearing for the plate-like elements is created, and thus inaccuracies in the relative height arrangement of the spacing elements can be balanced out. Furthermore, by means of the flexible design of the support elements an automatic restoring movement occurs even over a long period, which means that a reliable operating lifetime can be achieved. In this way a non-rigid support plane is created, which within certain tolerances allows reliable support with simultaneous transport on the support elements.

By means of the embodiment according to claim 9 during both the transportation and the actual laminating process the tempering of the plate-like elements to be conveyed can be controlled. In this way, the development of internal stresses caused by uneven tempering is avoided, whereby the lifetime or service life of the plate-like elements is significantly increased and furthermore waste can be avoided.

According to an embodiment described in claim 10, the feeding and removal of the plate-like elements is facilitated and can be automated if desired.

An embodiment according to claim 11 has also proved advantageous, as thus without much additional effort a secured advance movement can be performed on the spacing elements. In addition, by means of the belt even over a longer period the tempering element is prevented form getting dirty during the laminating process, and thus disruption-free operation is ensured over a longer period involving the least amount of cleaning.

The invention also relates to a method for operating a machine, in which the spacing elements can be moved into their first position, before the conveying means are put into operation, in order to move the plate-like elements over the tempering element. In this case it is particularly advantageous that the plate-like elements are only lowered onto the tempering element when they are positioned completely over the latter and uneven heating or cooling of the elements is avoided.

For a better understanding of the invention the latter is explained in more detail with reference to the following figures.

In a much simplified schematic representation:

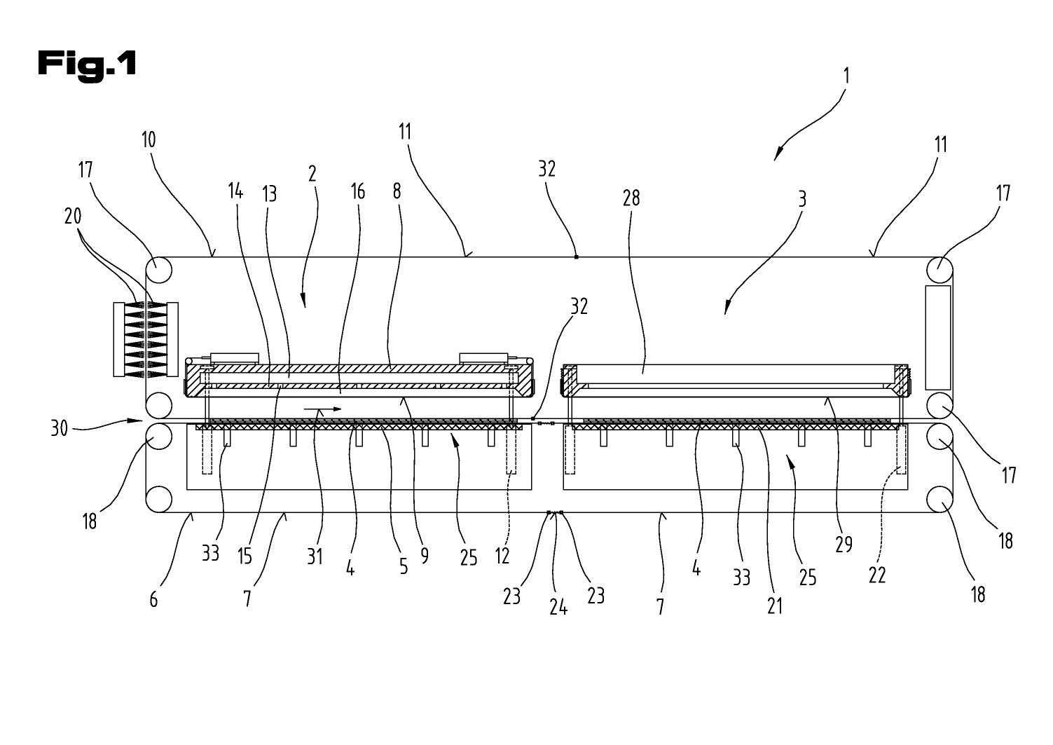

FIG. 1 shows a longitudinal section of a machine according to the invention for producing plate-like elements, in a supported position of the elements on the tempering elements and raised top parts;

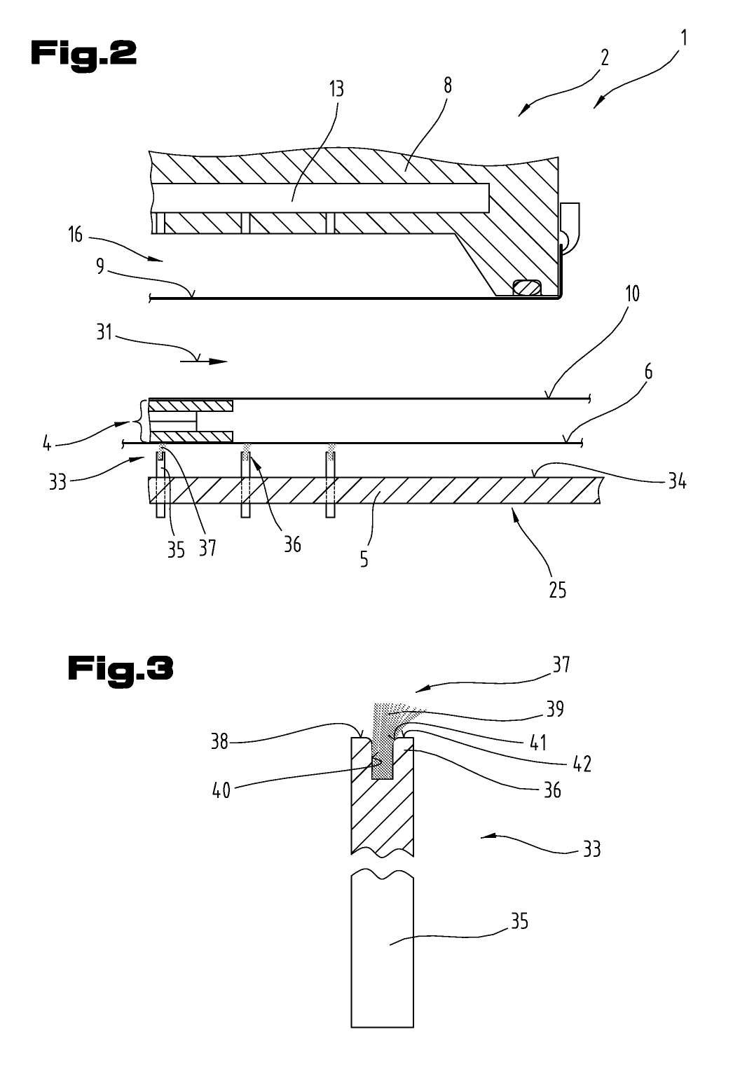

FIG. 2 shows a partial section of the machine according to FIG. 1, but with the plate-like element of the tempering element in a spaced apart position, in an enlarged and simplified view;

FIG. 3 shows a possible design of a spacing element, in cross section and in an enlarged view.

First of all, it should be noted that in the variously described exemplary embodiments the same parts have been given the same reference numerals and the said component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be transferred to the new position. Furthermore, also individual features or combinations of features from the various exemplary embodiments shown and described can represent in themselves independent and inventive solutions.

FIG. 1 shows a much simplified, schematic cross sectional view of the longitudinal axis of a machine 1 for joining or producing plate-like elements made of composite material. The machine 1 can also be mounted in a frame, but for a better overview the latter is not shown here.

In the machine 1 plate-like elements 4, such as photovoltaic elements, are transported by a conveying means 6 into a laminating station 2, where the elements 4 are laminated under the effect of pressure and heat. Afterwards, the elements 4 are transported by the conveying means 6 in the direction of an arrow 31, which represents the conveying direction, into a cooling station 3, where they remain under pressure for a specific period.

The laminating station 2 consists essentially of a heating panel 5 and a top part 8 which can be moved perpendicular to the latter. The reference numeral 12 denotes lifting drives, by means of which the top part 8 can be lowered and raised relative to the heating panel 5. On its lower side the top part 8 has a membrane 9, which in the lowered position of the top part 8 forms a closed chamber with the heating panel 5, which can be evacuated. In the case of an evacuated chamber the elements 4 to be laminated are pressed by the membrane 9 against the heating panel 5. Possible air pockets which might still be found between the layers of the elements 4 are suctioned off and thus removed. Furthermore, the adhesive provided between the layers of the elements 4 is activated by the pressure and the heat.

In the top part 8 between the membrane 9 and an intermediate wall 14 a chamber 16 is formed, which if necessary can be charged with underpressure or overpressure, in order to move the membrane 9 either towards the intermediate wall 14 or away from the latter, in the present case to lift it or push it downwards. A hollow chamber 13 provided in the top part 8 communicates with the chamber 16 by means of openings 15 arranged in the intermediate wall 14.

The cooling station 3 consists essentially of a cooling panel 21 and a top part 28 which can be moved relative to the latter by means of lifting drives 22, which top part 28, like the top part 8 of the laminating station 2, also has a membrane 29. The heating panel 5 and the cooling panel 21 can thus also be denoted tempering elements 25.

The conveying means 6 are in this example formed by preferably rectangular sections 7 of a flat, flexible material, which are held together by holding means 23 both on the front edge in conveying direction 31 and on the rear edge in transport direction. The holding means 23 of two adjacent sections 7 of the conveying means 6 are joined together by springs 24, so that the conveying means 6 forms a continuous loop guided over guiding rollers 18, the returning side of which is guided through underneath the cooling panel 21 and the heating panel 5.

A separating film 10 can be placed without tension onto each element 4 or group of elements 4 on an inlet side 30 into the machine 1, on the one hand, to protect the membrane 9 from dirt, for example from adhesive exiting out of the elements 4, and on the other hand, to avoid any forces especially on opening the laminating station 2, which could result in a relative movement between the individual layers of the elements 4.

The separating film 10 can be formed by several sections 11 arranged one behind one another or can also be continuous. In this way the separating film 10 can be held on its edge aligned running firstly at right angles to the conveying direction by holding means 32, which in the exemplary embodiment described here are in the form of a profile. The holding means 32 can be moved on both sides of the conveying path by a flexible drive, for example a chain conveyer not shown in detail, along the conveying path. The remaining edges of the sections 11 of separating film 10 are free, so that each section during transport through the machine 1 lies loosely on the elements 4. This is particularly advantageous on the path section from the laminating station 2 to the cooling station 3, because there the elements 4 are still hot and therefore the adhesive bonding the individual layers has not yet hardened, is therefore sticky and inclined to flow. If the separating film 10 were to be tensioned on said path section this could lead to an unwanted relative movement between the layers. In addition, the configuration described here has the advantage that with each section of the separating film 10 on one side holding means can be dispensed with and thus the springs connecting the sections can be omitted completely.

The flexible drive moving the holing means 32 runs in a circuit and the sections 11 of the separating film 10 are guided over guiding rollers 17, whereby they are transported back above the top parts 28 and 8 of the cooling station 3 and the laminating station 2 back to the inlet side 30 of the machine 1, left in FIG. 1. Above the machine guides can be provided (not shown), over which the free ends of each section of the separating film 10 are dragged. To prevent the sections 11 in the area, in which they are guided back substantially in vertical direction to the inlet side 30, from simply falling down, guides in the form of elongated brushes 20 aligned in conveying direction 31 are arranged. Rigid guides arranged on both surfaces of the separating film 10 would be unsuitable, as they would have to be spaced apart from one another so that the holding means 32 would pass through in between. Depending on the rigidity of the separating film 10 the latter could get folded back and forth at this distance between the guides, and in this way be bent in an undesired manner. However, the brushes can reach on both sides of the separating film 10 up to its surface, as its bristles give way, so that the holding means 32 can fit easily. For simplicity here a continuous belt passing in a loop is shown.

On the section on which the conveying means 6 and the separating film 10 after leaving the cooling station 3 are guided back to the inlet side 30 of the machine 1, cleaning devices that are not shown in more detail can be arranged, by means of which the conveying means 6 and the separating film 10 or sections 11 thereof are freed from impurities, such as residues of adhesive or the like. As shown clearly in FIG. 1, the conveying means 6 and the separating film 10 do not need to be the same length. For example the separating film can easily have one or more sections more than the transport means 6.

The plate-like element 4 formed or composed of several layers is placed in the region of the inlet side 30 onto the belt-like conveying means 6 and transported by the latter into the laminating station 2 in conveying direction 31. During this procedure the plate-like element 4 is heated by the heating panel 5 with a continually high temperature. This occurs due to the selected feed rate in the direction of the longitudinal extension or conveying direction 31 to a varying extent. The section of the plate-like element 4 which is in front in conveying direction 31 is thus exposed much longer to the tempering or associated heat absorption than the end of the plate-like element 4 following in conveying direction 31.

The same also applies however to the cooling panel 21 arranged in the cooling station 3. Here too during the further transportation of the plate-like element 4 from the laminating station 2 to the cooling station 3 a different cooling of the plate-like element 4 in conveying direction 31 takes place. This also results in the formation of internal stresses and thus to a poor final condition of the whole element 4.

To avoid this, for the transportation of the plate-like element 4 into the laminating station 2 or from the latter into the cooling station 3, there has to be thermal separation between the heating panel 5 and/or the cooling panel 21 and the plate-like elements 4. Furthermore, during the transportation the two top parts 8, 28 of the laminating and cooling station 2, 3 are arranged spaced apart from the heating panel 5 or cooling panel 21.

For thermal separation during the transport process a reliable and permanent spacing of the plate-like elements 4 from the heating panel 5 or cooling panel 21 is mostly sufficient for this period, without a separate and additionally shielding intermediate layers being necessary. Air is an insulating means, which in almost all cases is sufficient, to prevent to a large extent or completely prevent a tempering process (heat absorption, heat removal) during transportation.

For this purpose spacing elements 33 are provided, which are adjustable in vertical direction relative to the heating panel 5 or cooling panel 21. By means of said spacing element the lifting or lowering of the plate-like elements 4 to be conveyed from the heating panel 5 or cooling panel 21 is possible during the transportation. In this view however, the spacing elements 33 are shown in their position of rest, in which both the conveying means 6 and the plate-like elements 4 lie on the heating panel 5 or the cooling panel 21 and thus are in contact for tempering. A detailed description of the design of the spacing elements 33 and their function are given in the following figures.

FIG. 2 shows an enlarged detail of the machine 1 in the region of its laminating station 2, whereby for the same parts the same reference numerals and component names are used as in the preceding FIG. 1. To avoid unnecessary repetition reference is made to the detailed description for the preceding FIG. 1.

In contrast to the view in FIG. 1 the plate-like 4 is shown in a position that is lifted or raised position from the heating panel 5. This raised or spaced apart position is used here during the transport of the plate-like elements 4 from the inlet side 30 into the laminating station 2 or from the latter into the immediately following cooling station 3, in order to avoid the uneven tempering of the plate-like element 4. For a better overview, the use of adjusting means for operating the spacing element or elements 33 is omitted. In all of the embodiments shown here the spacing element 33 penetrates the heating panel 5 or cooling panel 21 and can be adjusted relative to said two panels 5, 21.

Regardless of this, it would also be possible to arrange or secure the spacing element or elements 33 to be fixed in relation to the machine 1 or its machine frame, and in addition to move the heating panel 5 and/or cooling panel 21 in relation thereto. In this way in both cases the plate-like elements 4 are spaced apart from a bearing surface 34 of the heating panel 5 and/or cooling panel 21.

It should be noted at this point that the arrangement and configuration of the spacing elements 33 according to FIG. 2 of the laminating station 2 can also be applied to the cooling station 3.

The spacing element 33 comprises a preferably pin-like carrier element 35, which has a first end area 36 which can face the plate-like element 4. As represented here in simplified form, in the section of the first end area 36 a support element 37 is arranged, which projects beyond the carrier element 35 in the direction of the top part 8, 28 or the plate-like element to be lifted.

In the previously described bearing position of the plate-like element 5 on the heating panel 5 or cooling panel 21 the spacing element 33 is arranged at least in the same plane as the bearing surface 34 of the tempering element 35 or even inside the latter. This prevents the projection of the latter over the bearing surface 34.

The carrier element 35 is mostly made of a solid, stable and bending-resistant material and has an end face 38 facing the plate-like element 4. To perform the advancing movement of the plate-like elements 4 the previously described spacing from the tempering element 25 should continue until the plate-like elements 4 are lowered for further processing onto the heating panel 5 and/or cooling panel 21 and then the top part 8 or 28 should be adjusted towards the heating panel 5 or cooling panel 21.

As the plate-like elements 4 are formed, at least in the region of the outer layers, by glass plates, the sole use of the carrier element 35 to form the spacing elements 33 is not advantageous, as here an exact mutual height alignment is necessary on using several spacing elements 33, in order thus to obtain a flat support of the plate-like element 4 on the spacing elements 33. Also further transport over the stable support elements 35 is disadvantageous and can result in damage to the surface.

If in addition the previously described belt-like conveying means 6 is used for the transport, due to the surface pressure on the bearing points of the plate-like element 4 and possibly on the end face 38 of the carrier element 35 heavy wear may occur and this can result in damage to the latter. This can lead to tearing which means that the belt-like conveying means 6 would be unusable.

As also shown in FIG. 2, the belt-like conveying means 6 is arranged in a position in which the spacing element 33 projects beyond the tempering element between the spacing element 33 and the plate-like element 4.

FIG. 3 shows an independent exemplary embodiment of the spacing element 33, wherein the same reference numerals or component names are used for the same parts as in the preceding FIGS. 1 and 2. To avoid unnecessary repetition reference is made to the detailed description for the preceding FIGS. 1 and 2.

The spacing element 33 shown here comprises the mostly pin-like carrier element 35 and the support element 37 arranged in its end area 36 facing the plate-like element 4. The support element 37 is designed to be flexible with respect to the carrier element 35 and can be formed from a plurality of individual threads 39 or strands combined into a bundle. Thus the support element 37 can also be referred to as being bristle-like. It is essential that the support element 37 provides a flexible support or mounting for the plate-like element 4, without the latter coming to bear directly on the end face 38 of the carrier element 35. With the configuration of the support element 37 from a bundle of threads 39 the latter are shaped elastically under loading and thus absorb the load to be removed. This position is indicated in a simplified manner in FIG. 3. After the removal of load the support element 37 then again adopts a position aligned largely in the longitudinal direction of the carrier element 35.

For simpler arrangement and mounting of the support element 37 a recess 40 is arranged in the end face 38 of the carrier element 35. Said recess 40 is designed in the form of a mounting opening and holds the support element 37 consisting mostly of a bundle of threads 39. In addition, adhesion to the carrier element 35 can be made possible in order not only to form the bundle but also to ensure suitably secure mounting.

In order to ensure a flexible transition from the recess 40 to the end face 38 of the carrier element 35, it is advantageous, if in this transition section a curvature 41 is provided towards an end face 42 of the carrier element 35. Preferably, the curvature 41 is continuous over the periphery of the recess 40. In this way additional damage to the individual threads 39 of the support element 37 is avoided in this transitional or support area.

The support element 37 can be selected in turn from a group of materials including metal, carbon, ceramics or plastic, such as for example PEEK (polyetheretherketone), aramid etc. If PEEK is used as the material, the latter is characterized by having a high usable strength and a high permanent load temperature of up to 250° C. with excellent bending strength and tensile strengths. At the same time the latter has a high level of toughness and excellent fatigue strength. In this way, a high degree of recoverability of the support element 37 is achieved after unloading and thus over a long period a reliable support of the plate-like elements 4 is obtained if necessary with the interconnection of the belt-like conveying means 6.

The exemplary embodiments show possible variants of the spacing element 33 and a machine 1 fitted with the latter, whereby it should be noted at this point that the invention is not restricted to the embodiment variants shown in particular, but rather various different combinations of the individual embodiment variants are possible, and this variability based on the technical teaching of the present invention lies within the ability of a person skilled in the art in this technical field. Thus all conceivable embodiment variants, which are made possible by combining individual details of the embodiment variant shown and described, are also covered by the scope of protection.

Lastly, as a point of formality, it should be noted finally that for a better understanding of the construction of the machine 1 the latter and its components have not been represented to scale in part and/or have been enlarged and/or reduced in size.

The underlying objective of the independent solutions according to the invention can be taken from the description.

Essentially, the individual embodiments shown in FIGS. 1, 2; 3 can form the subject matter of independent solutions according to the invention. The relevant objectives and solutions of the invention can be taken from the detailed description of said figures.

### LIST OF REFERENCE NUMERALS

| | |
|---|---|
| 1 | Machine |
| 2 | Laminating station |
| 3 | Cooling station |
| 4 | Plate-like element |
| 5 | Heating panel |
| 6 | Conveying means |
| 7 | Section |
| 8 | Top part |
| 9 | Membrane |
| 10 | Separating film |
| 11 | Section |
| 12 | Lifting drive |
| 13 | Hollow chamber |
| 14 | Intermediate wall |
| 15 | Opening |
| 16 | Chamber |
| 17 | Guiding roller |
| 18 | Guiding roller |
| 19 | |
| 20 | Brush |
| 21 | Cooling panel |
| 22 | Lifting drive |
| 23 | Holding means |
| 24 | Spring |
| 25 | Tempering element |
| 26 | |
| 27 | |
| 28 | Top part |
| 29 | Membrane |
| 30 | Inlet side |
| 31 | Conveying device |
| 32 | Holding means |
| 33 | Spacing element |
| 34 | Bearing surface |
| 35 | Carrier element |
| 36 | End area |
| 37 | Support element |
| 38 | End face |
| 39 | Thread |
| 40 | Recess |
| 41 | Curvature |
| 42 | Face side |

1. A spacing elements for spacing apart if necessary plate-like elements, such as photovoltaic elements, from a tempering element, such as a heating panel or cooling panel, with a carrier element, which comprises a first end area which faces the plate-like element, wherein the section of the first end area includes a flexible support element is arranged therein and which projects beyond the first end area of the carrier element.

2. The spacing element according to claim 1, wherein the support element comprises bristles.

3. The spacing element according to claim 1, wherein the support element comprises a plurality of individual threads or strands, or threads or strands combined into a bundle.

4. The spacing element according to claim 1, wherein the support element is arranged within a recess formed in an end face of the support element.

5. The spacing element according to claim 4, wherein the recess passes with a curvature into an end face of the carrier element.

6. The spacing element according to claim 1, wherein the support element is selected from a group of materials including metal, carbon, ceramics or plastic, such as PEEK (polyetheretherketone), and aramid.

7. The spacing element according to claim 1, wherein the support element is configured in the form of a pin.

8. A machine for producing plate-like elements, such as photovoltaic elements, with a tempering element, such as a heating panel or cooling panel and with spacing elements for spacing apart if necessary the plate-like element from the tempering element, wherein the spacing elements are configured according to claim 1.

9. The machine according to claim 8, wherein the spacing elements can be moved between a first position, in which the first end area projects over a bearing surface of the tempering element, and a second position, in which the spacing elements are arranged at least in the same plane as the bearing surface or inside the tempering element.

10. The machine according to claim 8, comprising conveying means for transporting the elements along a conveying path leading over the tempering element.

11. The machine according to claim 10, wherein the conveying means comprises a belt.

12. A method for operating the machine of claim 9, wherein the spacing elements are moved into their first position, before the conveying means are put into operation, in order to move the plate-like elements over the tempering element.
